(19) United States
(12) Patent Application Publication
(10) Pub. No.: US 2018/0293912 A1
(43) Pub. Date: Oct. 11, 2018

(54) Vocabulary Learning Central English Educational System Delivered In A Looping Process

(71) Applicant: Zhi Ni, Foster City, CA (US)

(72) Inventor: Zhi Ni, Foster City, CA (US)

(21) Appl. No.: 15/485,181

(22) Filed: Apr. 11, 2017

(51) Int. Cl. G09B 19/06; G09B 5/06; G09B 7/08

(52) U.S. Cl. CPC G09B 19/06; G09B 7/08; G09B 5/065

(57) ABSTRACT

In today's English education field, English learning typically focuses on reading comprehension and writing. Students learn vocabulary along the way. However, there are many English learners, especially English as a second language students, whose vocabulary levels are often much lower than their reading comprehension levels. Vocabulary learning, often confused by many people as vocabulary memorization, is very critical and more than simply memorizing word definitions. Vocabulary usage, such as reading, listening, speaking, and writing with words, is a critical part of vocabulary learning. In addition, to ensure mastery of learning, these learning materials need to be delivered in a looping process over multiple time intervals over a time span. To help millions of people learning English, I invented a vocabulary learning central English educational system in which learning materials are built around tiered, grouped and expanded words over time intervals over a time span.

### BACKGROUND OF THE INVENTION

In today's English education field, the standard learning typically focuses on reading comprehension and writing. Students learn vocabulary along the process of learning reading comprehension and writing.

However, there are many English learners whose vocabulary levels are often much lower than their reading comprehension levels. Here are some example categories of those learners who need improvement on vocabulary skills greatly:
New immigrant adult students born outside of the United States
New immigrant adults' children born outside of the United States
New immigrant adults' children born in the United States
US born native English speaking students simply having a hard time to memorize words due to various reasons
   At Ivy Goal Education (IGE), we have encountered many new immigrant students who can comprehend well if they know English words. Vocabulary is the main obstacle stopping them from reading, writing, speaking and listening.
   The existing English educational system does not put vocabulary development as number one English learning objective.

There are a lot of vocabulary students in American.

Vocabulary learning is often confused by many people as vocabulary memorization. However, vocabulary learning is very important and much more than simply memorizing word definitions.
Vocabulary learning is defined as a learning comprises:
Understanding vocabulary words definitions
Phonics rules for sounding out words
Orally to use words in speech and conversations
Understanding words from listening
Understanding the different subtle meanings and usages in different reading materials
Spelling of the words
Using words to write sentences
Using words to write stories
Translation of words between English and other languages
How words to form short phrases
How words are related to other words
   Vocabulary students are defined as the students for whom vocabulary learning is the main learning objective.
   English as a Second Language Learning has many different terminologies, such as, English as a Second Language (ESL), English as an additional language (EAL), English for speakers of other languages (ESOL), English Language Development (ELD), English Language Learners (ELL), and more recently English Learners (EL). For this patent application, we will use EL to represent this type of learning.
   Here is EL student data in California based on Fall 2015 California Language Census.
The 1,373,724 English learners constitute 22.1 percent of the total enrollment in California public schools.
A total of 2,664,921 students (English Learners and Fluent English Proficient) speak a language other than English in their homes. This number represents about 42.8 percent of the state's public school enrollment.
The majority of English learners (73 percent) are enrolled in the elementary grades, kindergarten through grade six. The rest (27 percent) are enrolled in the secondary grades, seven through twelve, and in the ungraded category.
   Based on our teaching experience at IGE, many EL students are vocabulary students.

Compare Existing EL Educational System with IGE vocabulary learning System With reference to FIG. 8, FIG. 8-1, FIG. 8-2, FIG. 8-3, and FIG. 8-4, we can clearly see:
English assessment for EL learners are not developed around vocabulary skills.
EL students do not get placed mainly based on vocabulary skill levels.
Learning materials for EL learners are not developed around vocabularies.
   For many EL students, the current EL system is not effective. It often takes 3-7 years for students to move out of EL classes based on studies done by many different research organizations. Here is a quote on Lecturalbooks.com:

“When it comes to English language learners (ELL), a common question is how long they will need special services. According to a recent study conducted by Stanford University, in two California districts that are considered the most successful in teaching English to “limited English proficiency” (LEP) students, oral proficiency takes 3 to 5 years to develop, and academic English proficiency can take 4 to 7 years.”

At IGE, the new vocabulary learning English Educational System has delivered amazing results:
Within 3-12 months, about 80% of new immigrant students (come to US about 6+-months ago) moves out EL classes and moves into regular English classes with native English speaking students.
   Comparing to existing EL learning system, new system developed by IGE is substantially more effective for many EL students.
   In conclusion, our new vocabulary learning English educational system can help millions of vocabulary students to improve English skills quickly.

### SUMMARY OF THE INVENTION

This invention relates to a system and a method for vocabulary learning English education. The system may include portable, desktop, virtual reality and online softwares to deliver the teaching method, system and materials easily. The system will make English learning much easier and quicker for vocabulary students.

English vocabularies are divided into many tiers and groups based on difficulty levels and general US education standard. For k-12th grade education, words are broken into Pre-K, K, 1st to 12th grade and advanced tiers. Within each tier, there are generally 15-20 groups. Each group has about 10-20 words, most commonly 10 words per group. For example, “butterfly, caterpillar, change, cocoon, hangs, harmless, scare, screams, snake, twin” as a group. In addition, expanded vocabularies will be taught in conjunction with these groups of words.

A set of learning materials then developed around this group of words and its expanded words, including, but not limited to, listening comprehension, reading comprehension, writing, speaking, and vocabulary drills, virtual reality and games.

This set of learning materials will be taught in a looping sequence over time intervals over a time span.

This learning method and system has delivered amazing results since our pilot programs in May 2014. Our 1st to 12th grade vocabulary students generally can master one grade level of vocabulary (around 200-300 words) and another 400-600 expanded words after 20 hours of teaching and 20-30 hours self practices over 4+-weeks of time span. For example, an 8th grade new EL immigrant student can quickly move into standard English classes after 6-12 months of learning under our system and method. For the same type of students, it is common to take them three years or more to move into standard English class under the current EL system.

### BRIEF DESCRIPTION OF DRAWINGS

FIG. 1: Vocabulary Learning Educational Looping System

FIG. 1-1: Initial Assessment Example

FIG. 1-1-1: English Vocabulary to Chinese

FIG. 1-1-2: English Vocabulary Complete Sentence

FIG. 1-1-3: Reading Comprehension

FIG. 2: Sample Learning Materials for an 8th Grade New Immigrant at 6th Grade Vocabulary Level

FIG. 2-1: Words Definition & Video

FIG. 2-2: English Vocabulary to Chinese

FIG. 2-3: Reading with Vocabulary

FIG. 2-4: Vocabulary Sentence Writing

FIG. 2-5: Chinese to English Vocabulary

FIG. 2-6: Game-based Vocabulary Spelling

FIG. 2-7: Game-based Vocabulary Listening Comprehension

FIG. 2-8: Game-based Vocabulary Dialog

FIG. 2-9: Game-based Vocabulary Sentence Completion

FIG. 2-10: Virtual Reality (VR) Learning Materials—Students Interact with VR Environment

FIG. 2-11: VR Learning Materials—Students Interact with Teachers

FIG. 2-12: VR Learning Materials—Students Interact with Each Other

FIG. 2-13: VR Learning Materials—Students Are Only Audiences, But Actively Involved & Engaged

FIG. 2-14: Characters Can Take Many Different Forms in VR Environment

FIG. 3: Standard Looping Unit 6 After Initial Lesson Unit 6

FIG. 4: Reassessment Unit After Initial Lesson 10

FIG. 5: Selective Looping Unit After Initial Lesson 15

FIG. 6: Sample Learning Materials for 8th Grade English Speaking Only Students at 6th Grade Vocabulary Level

FIG. 7: Sample Learning Materials for an 8th Grade New Immigrant at K-Grade Vocabulary Level

FIG. 8: Existing English Educational Curriculum Comparing to IGE vocabulary learning English Learning Curriculum

FIG. 8-1: Existing EL Assessment in California—CELDT

FIG. 8-2: Existing Placements for English Learners Based on California Department of Education

FIG. 8-3: Existing Annual Assessment for English Learners Based on California Department of Education

FIG. 8-4: Existing “California English Language Development Standards” for English Learners (Mostly English As a Second Language)

### DETAILED DESCRIPTION OF THE PREFERRED EMBODIMENT

Vocabulary Learning English Educational Learning Materials Delivered In A Looping System

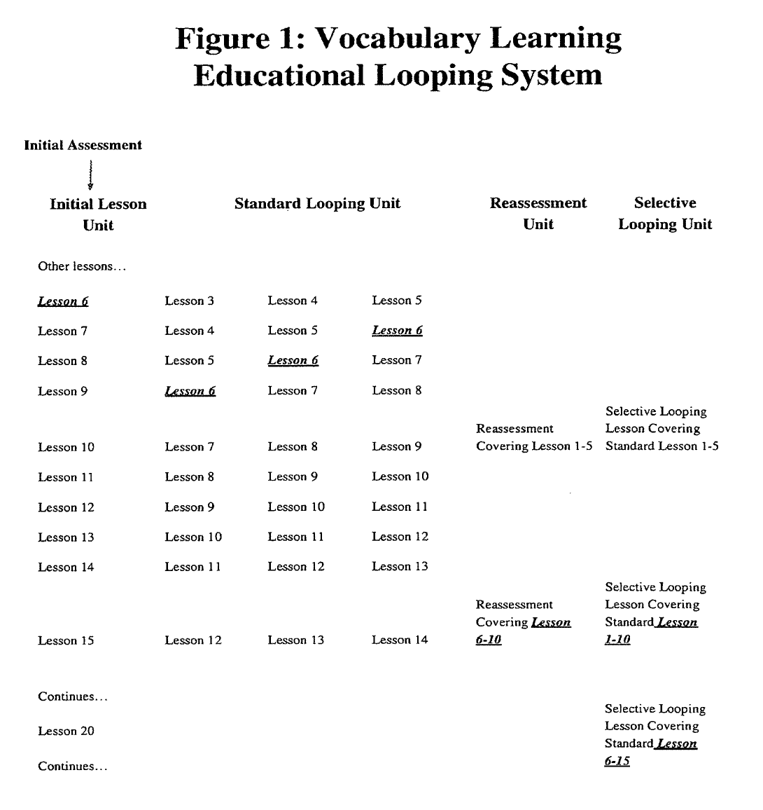

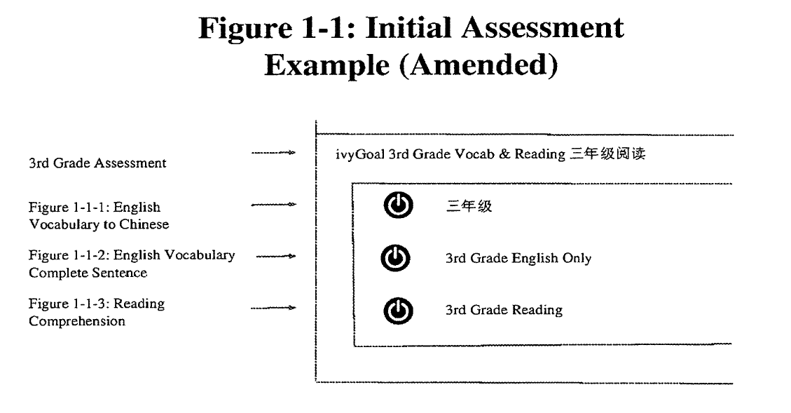

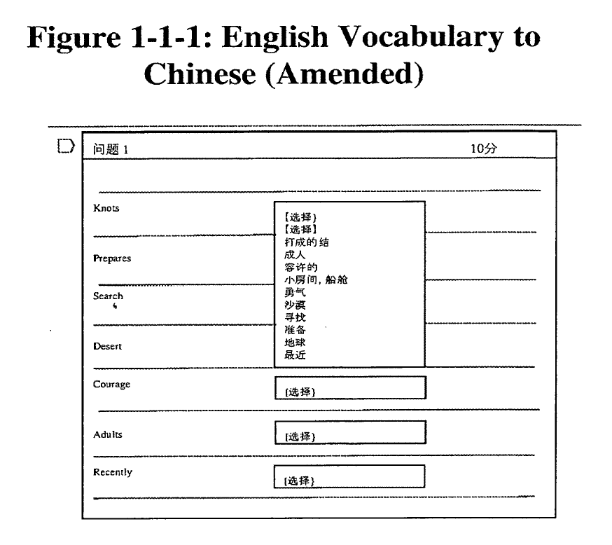

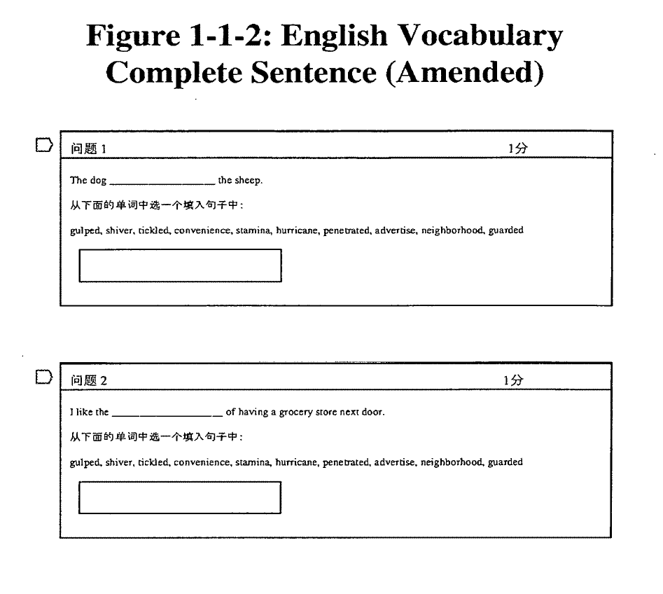

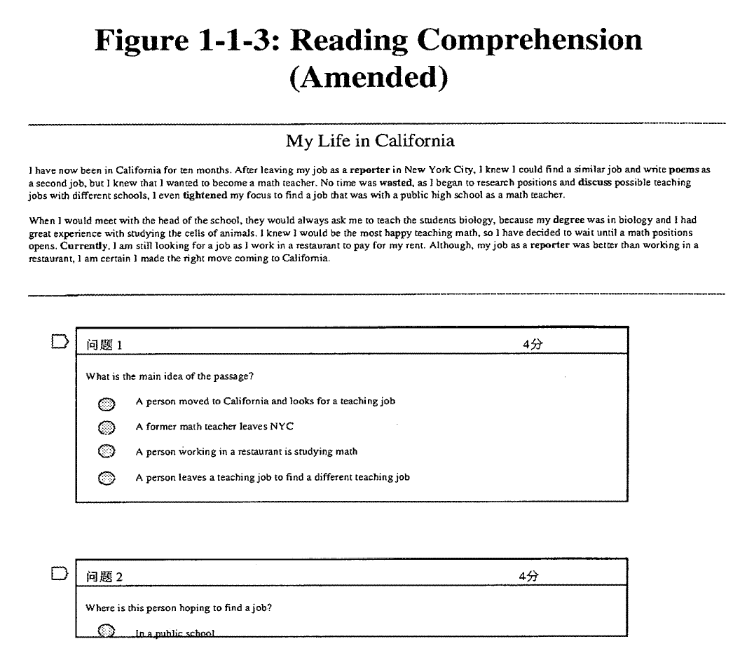

With reference to FIG. 1, there illustrates an exemplary system that may address and overcome the major learning problems for vocabulary students.

### Definition of Important Concepts and Terms

Tier is defined as a learning level, based on vocabulary difficulty levels according to US educational standard and custom. A tier will have many groups of words.
Grouped words is defined as meaningful and related words grouped together for vocabulary educational purpose. Grouped words need to be at similar difficulty level based on US education custom and standard. For example, words: breakfast, dark, pool, slippery, spin, star, sweater, wonderful, wind and sky are at similar difficulty level and can be grouped. A group is a part of tier.
Expanded words is defined as words expanded from grouped words based on their close relationships. For example, for the word “Condition”, expanded words can be “Conditional”, “Conditioned”, “Conditioning”, “Unconditional” . . .
Initial assessment is defined as the first assessment for students to identify their English skill levels mainly based on vocabulary and determine their starting learning level.
Reassessment is defined as an assessment for existing vocabulary students to identify their learning progress and weaknesses.
Learning Materials is defined as learning materials, developed around grouped and expanded words, including but not limited to, listening, speaking, reading, spelling, writing sentences, writing stories, puzzles, games, video, vocab quiz, dual language learning, translation, virtual reality materials and others.
Virtual Reality is defined as the computer-generated simulation of a three-dimensional image or environment that can be interacted with in a seemingly real or physical way by a person using special electronic equipment, such as a helmet with a screen inside or gloves fitted with sensors.
A Lesson, also called as a Standard Lesson, is defined as all learning materials built around the same set of grouped words and expanded words, to be assigned to students to reach learning mastery, which is typically average 80% correct on all learning materials and reassessments.
The lesson material requirements to reach learning mastery can vary for different learning difficulty levels, different types of learners and each individual learner's performance:
For example, for 9th grade level, the number of materials needed can be greater than 2nd grade level because 9th grade level materials are more difficult.
For example, for the same 2nd grade level materials, a 12 year old student may have less materials to study than an adult because a 12 year old student tends to learn faster than an adult.
For example, for the same 2nd grade level materials and same age of students, one student may have less learning materials to study than the other because the first student learns faster.
   A lesson is often spread into different units: initial lesson unit, standard looping units, reassessment unit and selective looping unit.
   Unit is defined as a module containing group of learning materials that may come from one or more different lessons.
   An Initial Lesson is defined as:
A part of a standard lesson.
The first set of learning materials of a lesson assigned to students based on initial assessment results.
   Initial Lesson Unit is defined as a unit holding materials for an initial lesson for the same grouped and expanded words.
   Learning Process is defined as a process to deliver learning materials. The process includes performing and delivering initial assessment, initial lesson units, standard looping units, reassessment units, and selective looping units.
   Looping is defined as a process to deliver learning materials in units over time intervals over a time span.
   Time Interval is an amount of time between the first looping unit and the second looping unit.
   Standard Looping Unit is defined as a unit holding learning materials for standard looping purpose. This unit has learning materials from different lessons.
   Standard Looping is defined as the looping process to deliver standard looping units to complete a lesson.
   Reassessment Unit is defined as a unit to have learning materials to assess students' learning of the lessons completed. This unit has learning materials from different lessons.
   Selective Looping Lesson is defined as all the learning materials created for selective looping purpose. It is not part of standard lesson. Learning materials are often selected from different standard lessons for re-education purpose.
   Selective Looping Unit is defined as a unit for selective lessons.
   Selective looping is defined as a process to deliver selective looping units over time intervals over a time span.

### The Vocabulary Learning Method to Create Assessment Materials

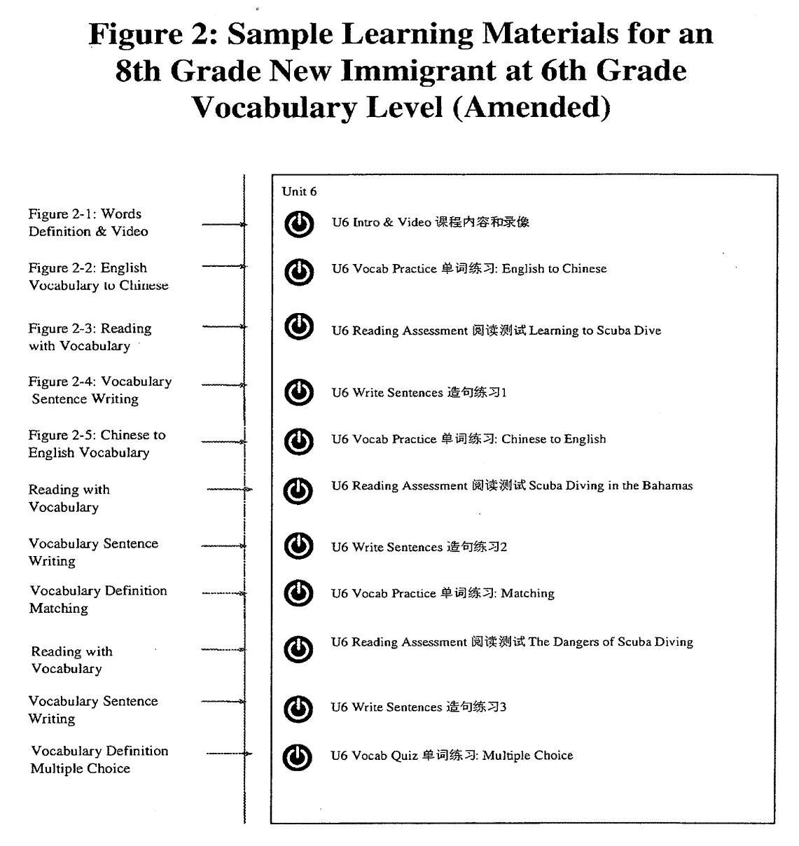

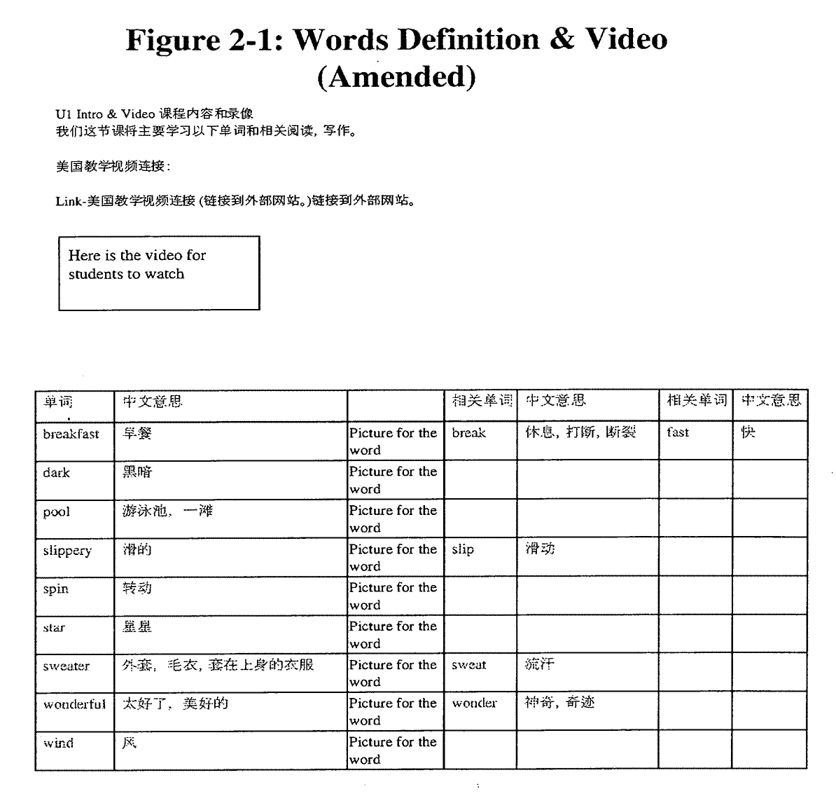

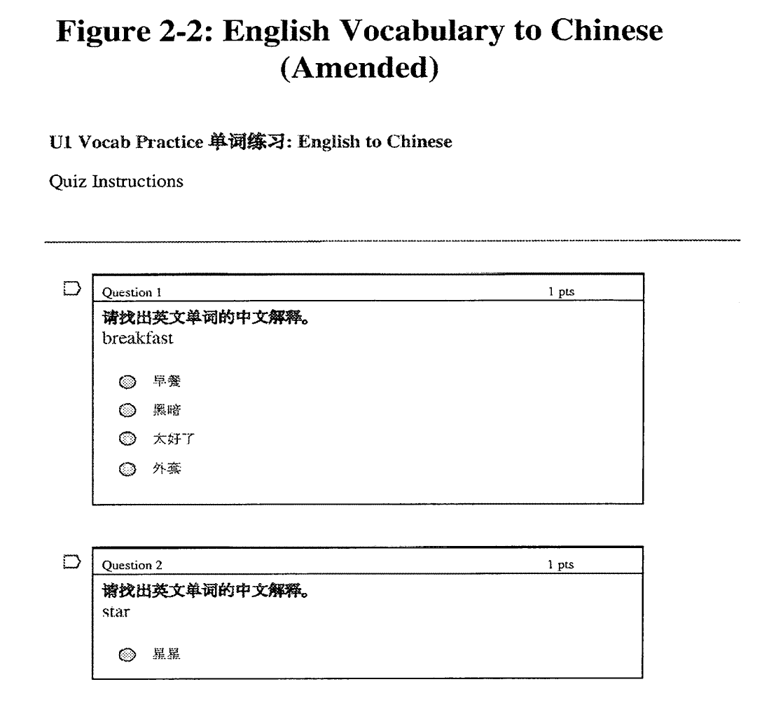

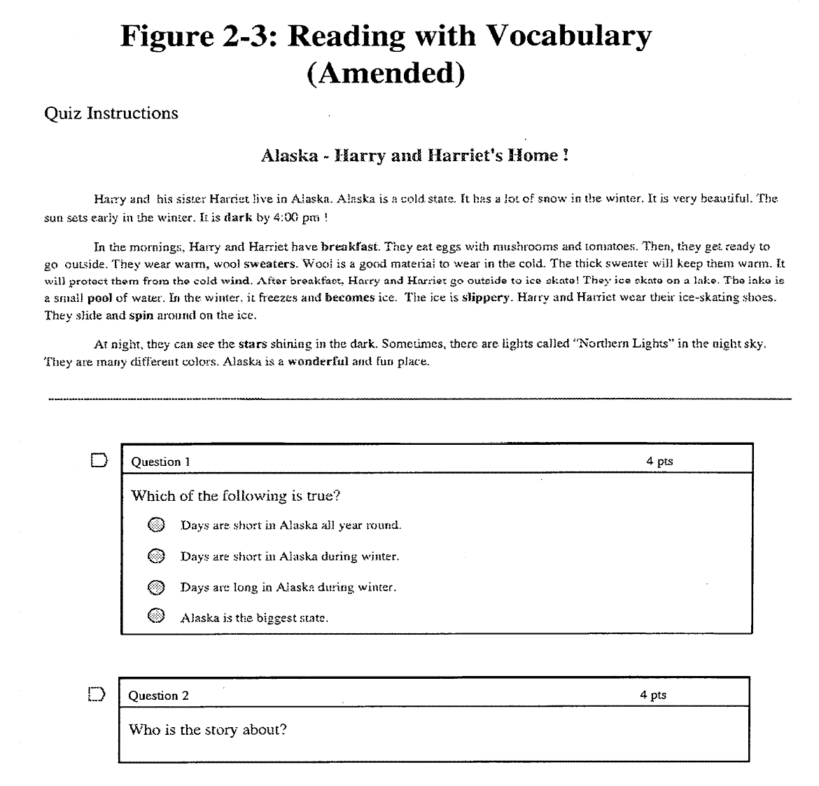

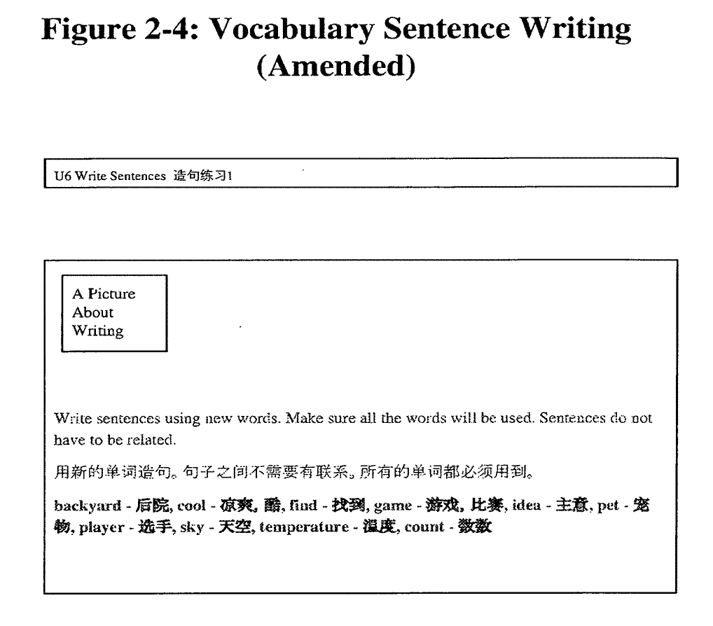

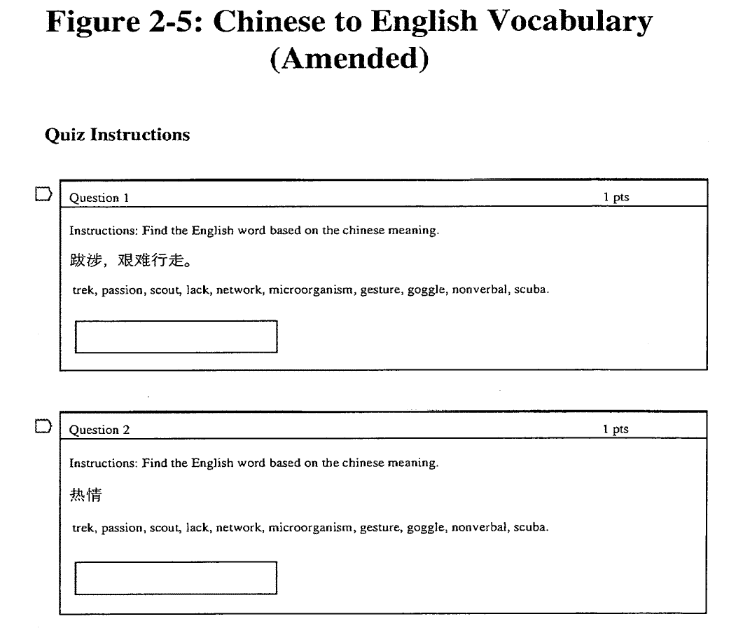

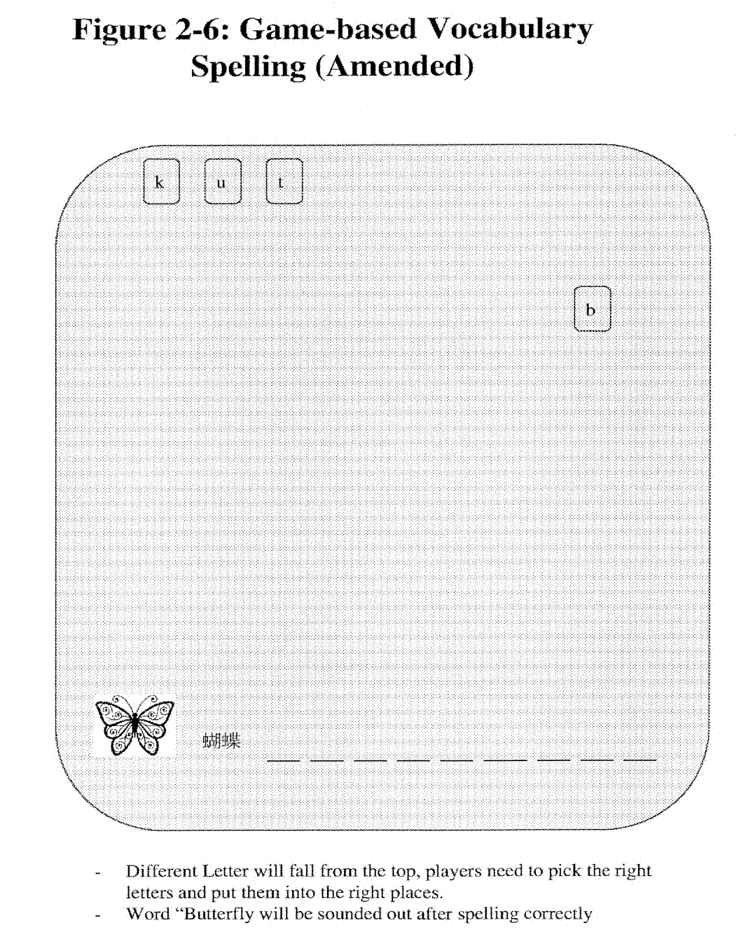

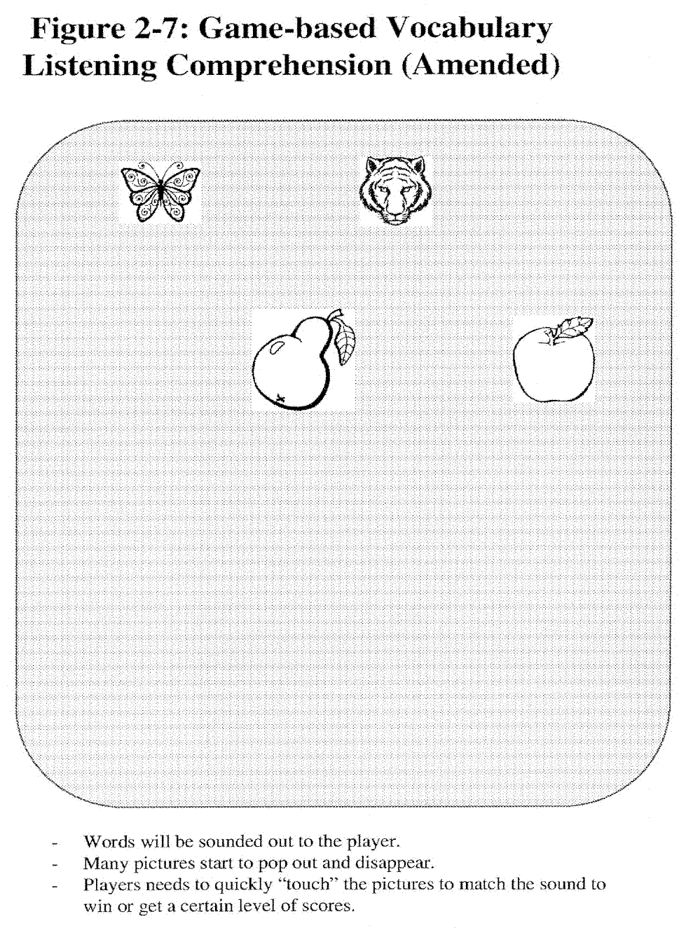

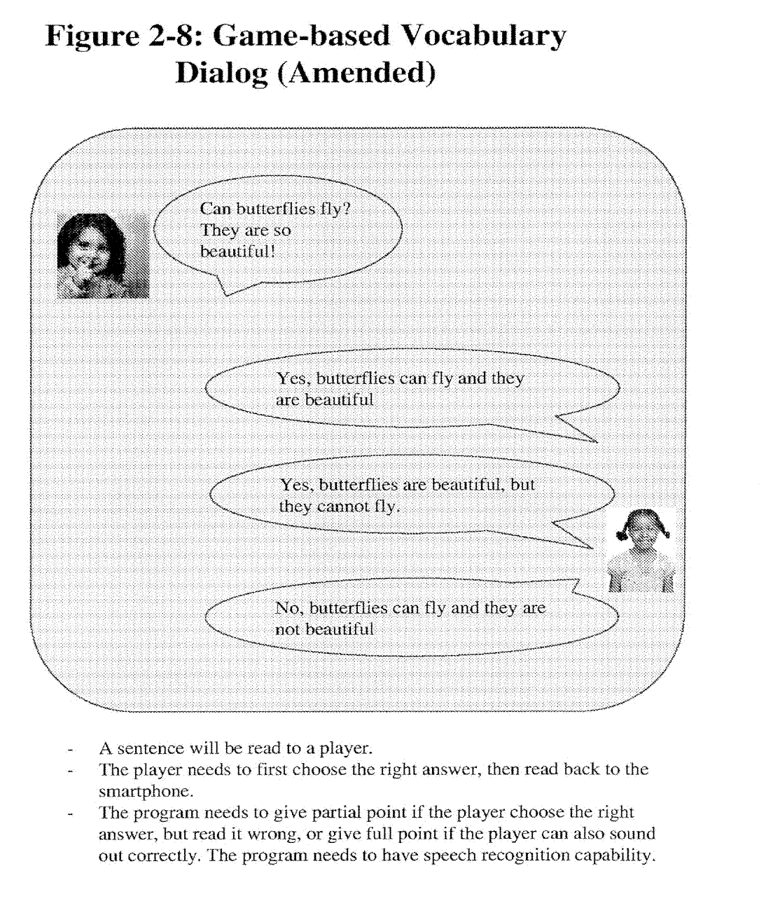

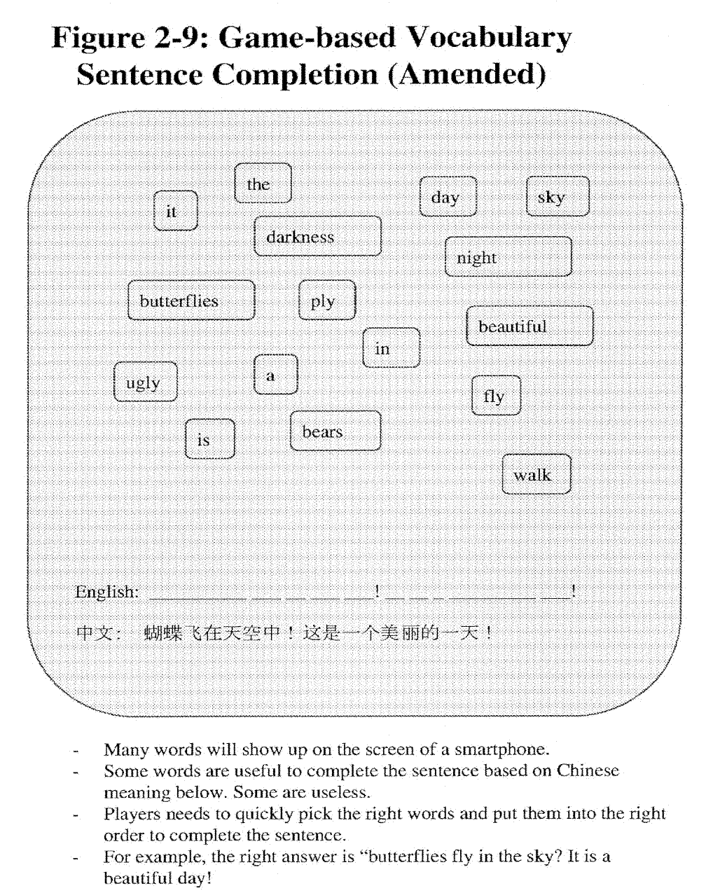

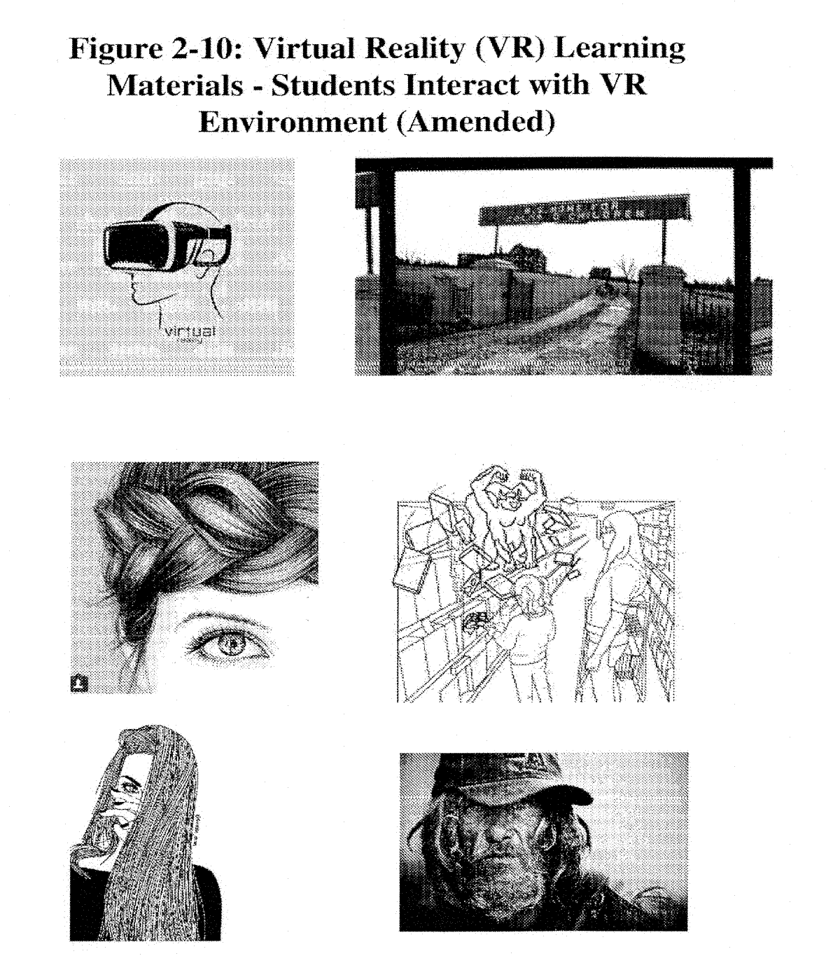

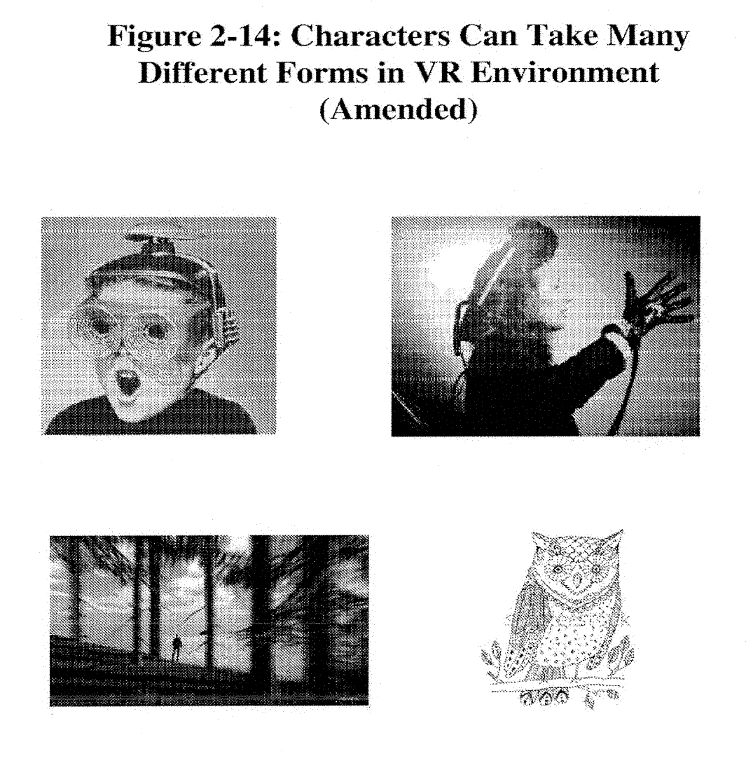

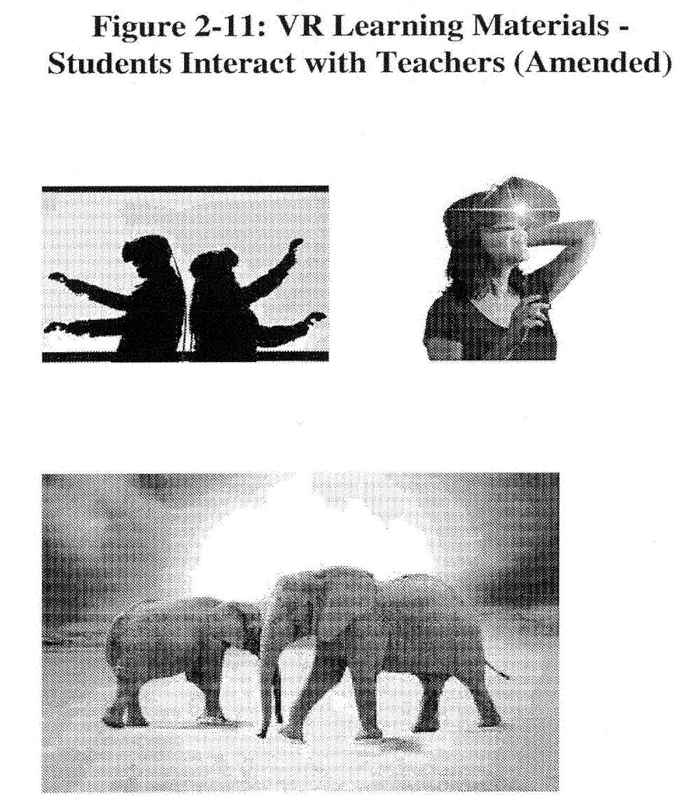

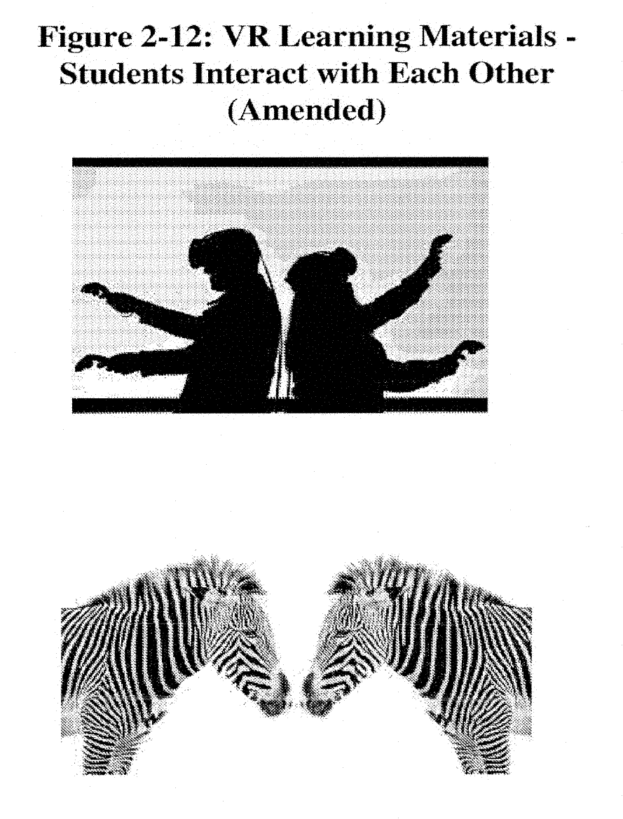

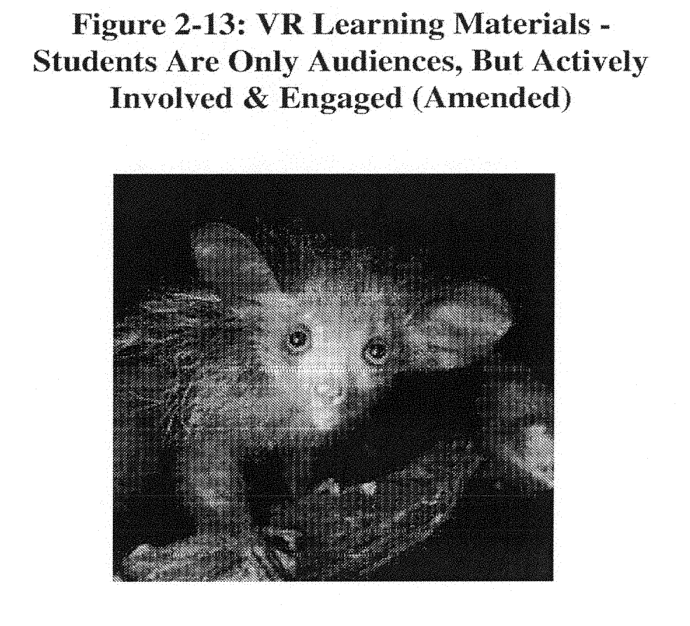

The EL assessment in California is called CELDT. With reference to FIG. 8-1 and FIG. 8-3, the current EL education systems evaluate student English levels based on a combination of vocabulary, reading, listening, speaking, writing and other related skills.
With reference to FIG. 8-2 and FIG. 8-3, based on the combined assessment results, students will be placed into an EL level. For many EL students, vocabulary is their lowest skill level. The current combined assessment, where vocabulary is not the main assessment metric, often places EL students into EL levels that are higher than their vocabulary levels, leaves significant vocabulary skill gaps, and causes poor learning results.
Vocabulary students, including many EL students, assessment materials should focus on vocabulary levels. Here is an example of vocabulary learning assessment used at IGE:

With reference to FIG. 1-1 Initial Assessment Example, English Vocabulary to Chinese (FIG. 1-1-1) weights 33.33%, English Vocabulary Complete Sentence (FIG. 1-1-2) weights 33.33%, Reading Comprehension (FIG. 1-1-3) weights 33.33%. In this example, vocabulary weights 66.67% in total.

### Vocabulary Learning Method to Create Learning Materials

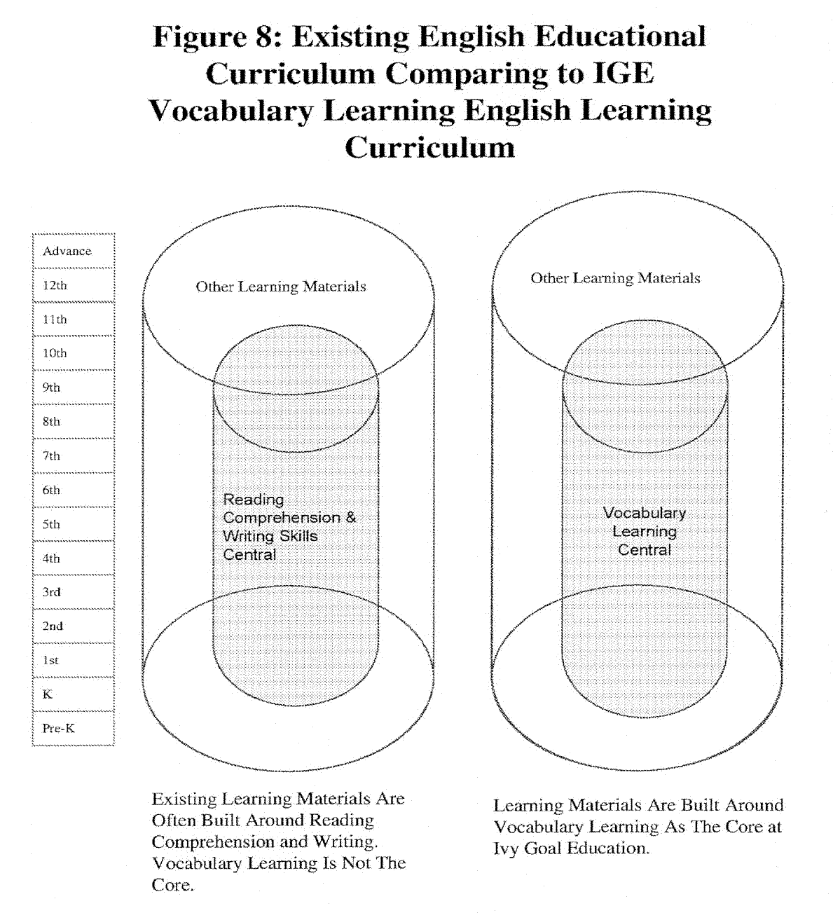

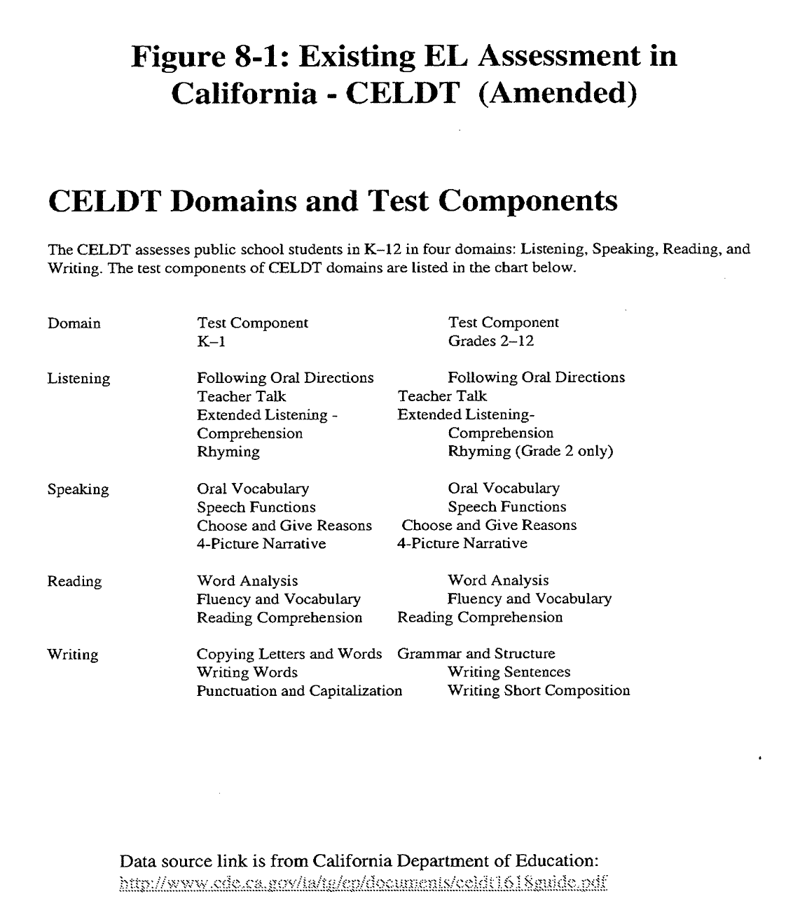

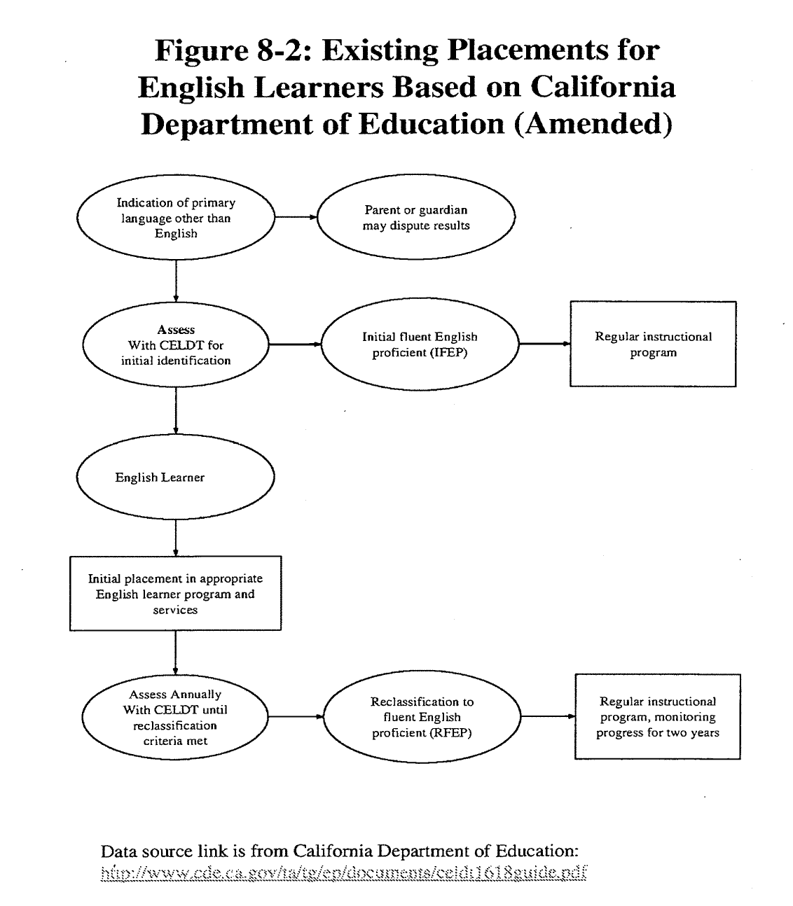

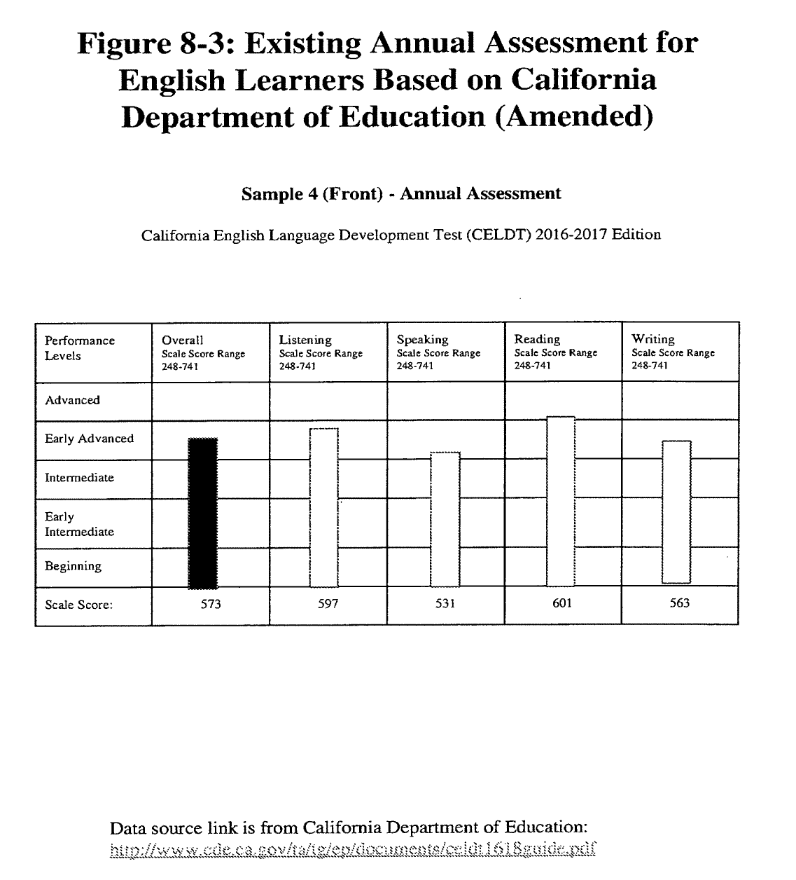

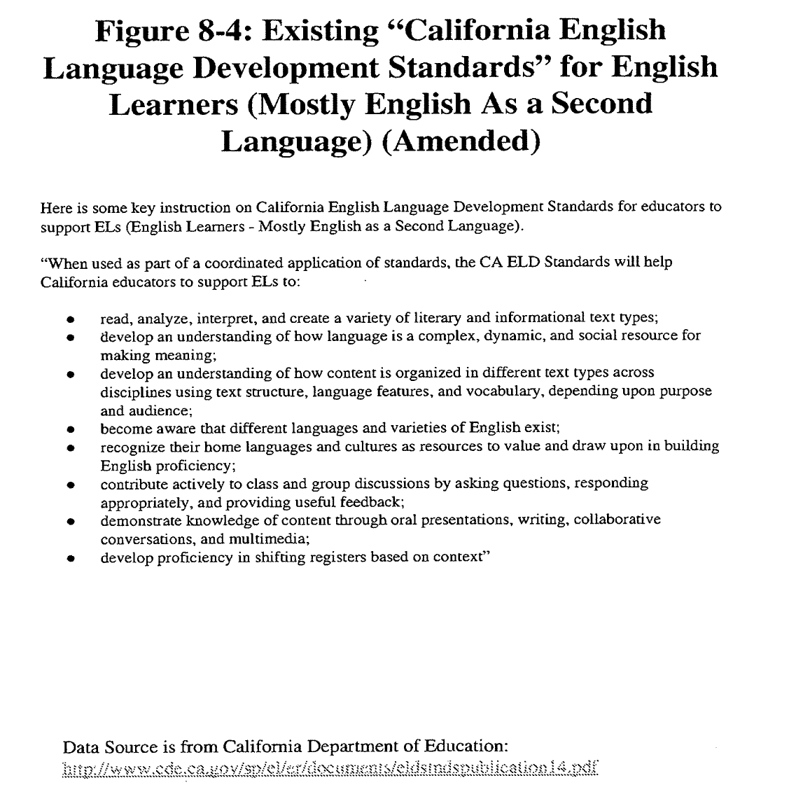

With reference to FIG. 8, current English educational learning materials are often built around reading comprehension and writing skills. However, the current method and system do not work well for vocabulary students for whom vocabulary is their biggest weakness.
Under IGE's new English educational method and system, for vocabulary students, all learning materials are developed around grouped vocabulary and its expanded vocabulary.

### For Different Tiers and Different Types of Students, The Numbers of Learning Materials Should be Different

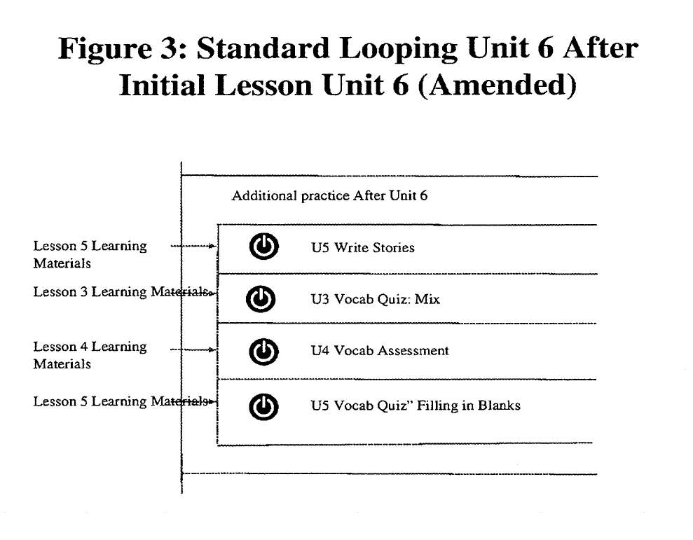

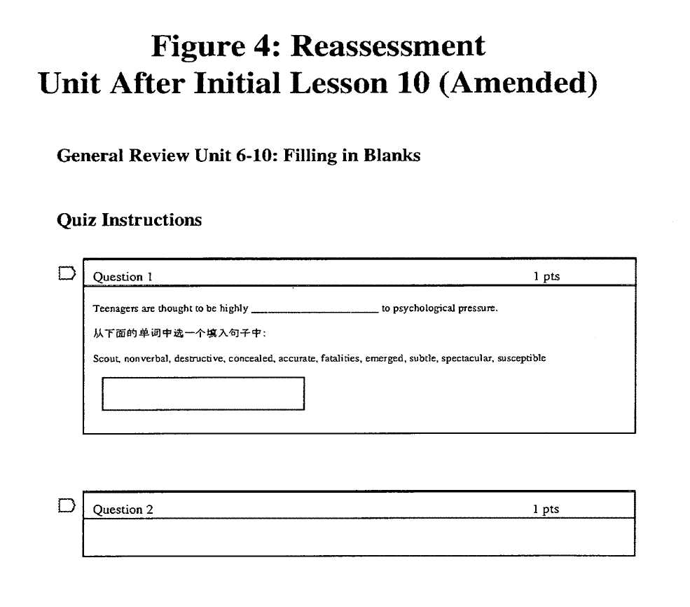

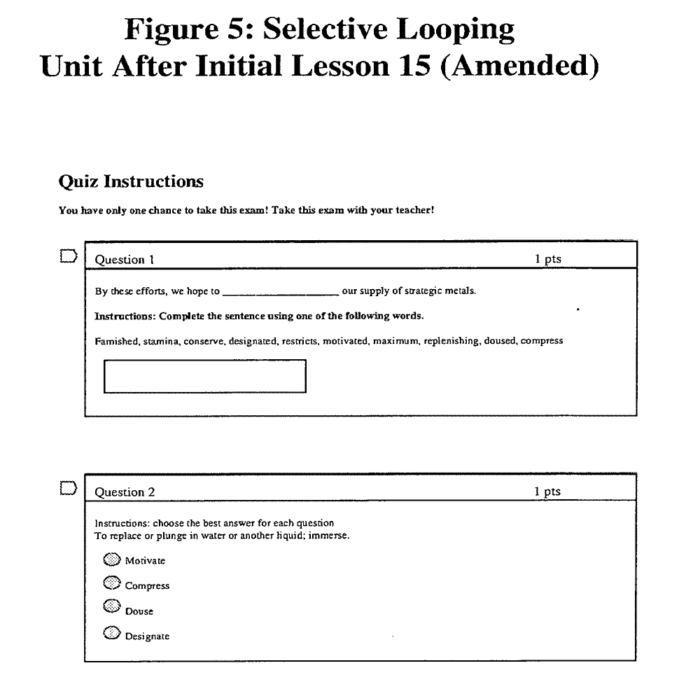

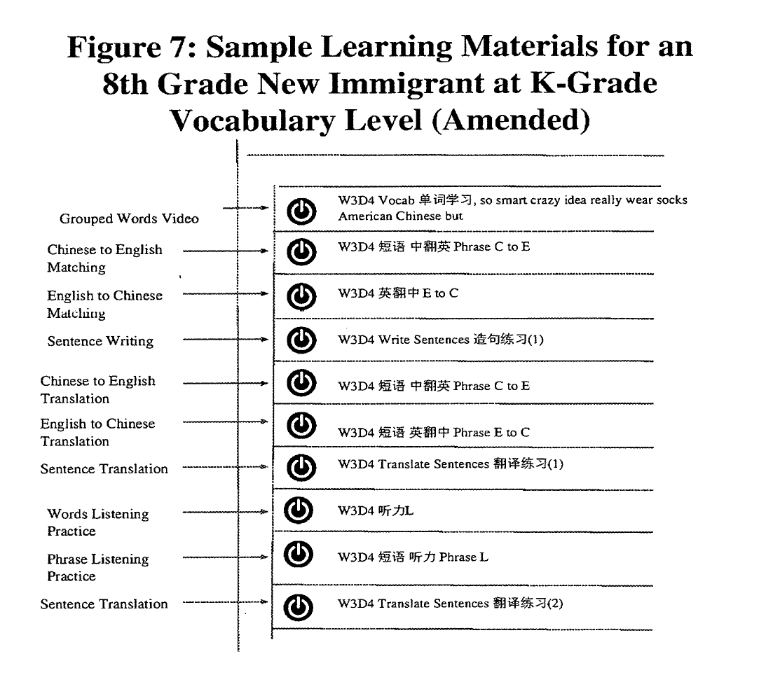

With reference to FIG. 7: Sample Learning Materials for a 8th Grade New Immigrant at K-Grade Vocabulary Level, the learning material has:
1. Words Definition & Video
2. Chinese to English Matching
3. English to Chinese Matching
4. Sentence Writing
5. Chinese to English Translation
6. English to Chinese Translation
7. Sentence Translation
8. Words Listening Practice
9. Phrase Listening Practice
10. Sentence Translation
   With reference to FIG. 2: Sample Learning Materials for an 8th Grade New Immigrant at 6th Grade Vocabulary Skill Level, the learning material has:
1. FIG. 2-1: Words Definition & Video
2. FIG. 2-2: English Vocabulary to Chinese
3. FIG. 2-3: Reading with Vocabulary
4. FIG. 2-4: Vocabulary Sentence Writing
5. FIG. 2-5: Chinese to English Vocabulary
6. Reading with Vocabulary
7. Vocabulary Sentence Writing
8. Vocabulary Definition Matching
9. Reading with Vocabulary
10. Vocabulary Sentence Writing
11. Vocabulary Definition Multiple Choice

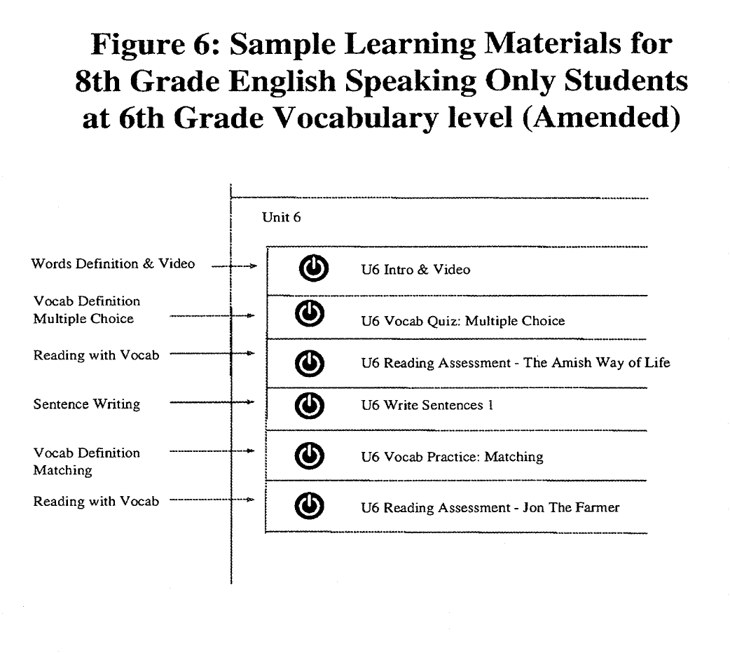

With reference to FIG. 6: Sample Learning Materials for 8th Grade English Speaking Only Students at 6th Grade Vocabulary level, the learning material has:
1. Words Definition & Video
2. Vocabulary Definition Multiple Choice
3. Reading with Vocabulary
4. Sentence Writing
5. Vocabulary Definition Matching
6. Reading with Vocabulary
   With reference to FIG. 7, FIG. 2 and FIG. 6, the numbers of learning materials for initial lessons are different.
   The general recommendation for the number of learning materials to be used for a lesson is the following:
30+—for new immigrant adult students born outside of the United States
15+—for new immigrant adults' children born outside of the United States
10+—for new immigrant adults' children born in the United States
10+—for US born native English speaking students simply having a hard time to memorize words due to various reasons

### For Different Tiers and Different Types of Students, The Focus of Learning Materials Should be Different

The general recommendation for types of learning materials is the following:
For US born vocabulary students:
   Focus on vocabulary definition, synonyms, antonyms, expanded words
   Reading with grouped vocabulary words
   Vocabulary sentence writing & story writing
For new immigrant vocabulary students, in addition to the learning materials above, the following is highly recommended:
   Translation between English and student's native language.
   Bilingual learning—learning materials in dual languages.
   Vocabulary and short phrase listening comprehension
   Vocabulary speaking and pronunciation practice.

### Detailed Process to Create Learning Materials

Step 1 Identify the vocabulary words for the educational system.
For different learning outcomes, vocabulary selection can vary.
For example, for K-12th grade students, standard for K-12th grade study can be used for the vocabulary selection. At Ivy Goal Education (IGE)—tutoring center, we have selected about 3,500 words that are commonly used in K-12th grade curriculum.
Another example, for SAT test prep, commonly tested SAT vocabulary can be selected.
   Step 2 Break the selected vocabulary into different tiers and groups
   The total selected words are often within 2,000-5,000 range. For example,
SAT words are often around 2,000.
K-12th grade words are around 3,500. In order to teach effectively, these words need to be grouped in a meaningful way. At IGE,
   we break these 3,500 words into 15 tiers (grade levels): Pre-K, K, 1st, 2nd, 3rd, 4th, 5th, 6th, 7th, 8th, 9th, 10th, 11th, 12th and Advanced;
   each tier has about 200-400 words;
   at each tier, we further break the words into groups. We typically have 15-20 groups per grade level. Each group has about 10-20 words.
      Step 3 Group meaningful, similar difficulty level and related words together
      For example, “butterfly, caterpillar, change , cocoon, hangs, harmless, scare, screams, snake, twin” as a group. These are at similar difficulty level and can be related to be used to write stories using the words together.
      Step 4 Create expanded words based on grouped words
      For example, for the word “Condition”, expanded words can be “Conditional”, “Conditioned”, “Conditioning” . . . Typically only 3+-most common expanded words will be selected. As a result, each group of words, including both grouped and expanded words, can have 40-80 words, and each tier can have 800-1,600 words. Total words for 15 tiers can be 15,000+-words.
      Step 5 Create many different types of learning materials based on the grouped words and expanded words
      FIG. 7, FIG. 2 and FIG. 6 show many examples of different learning materials.
      Step 6 The time to complete each learning materials for the majority of learning materials in standard looping units and selective looping units need to be short. The key method is not to reteach the words, but to refresh previous learning of the words.
      Step 7 Create vocabulary practices in dual languages if students' native language is not English
      Dual language exercises are much easier for students to learn English because they do not need to use dictionaries to check meaning or use translators to translate. FIG. 7 and FIG. 2 show many examples of dual language learning materials.
      Step 8 Create vocabulary practices with more graphic contents
      FIG. 2-1 has video and pictures to explain the meanings and usages of the words.
      Step 9 Create vocabulary practices in real settings in videos
      For example, if we want to teach words related to obtaining driver's license, it will be very helpful to shoot video on streets or in DMV offices to show students the real environments.
      Step 10 Create game-based vocabulary practices
      Game-based vocabulary practices will increase vocabulary learning efficiency. There are many ways to create vocabulary games.
      For example, on a smart-phone, an APP can be developed for students to play vocabulary games. Here are some sample vocabulary games.

### FIG. 2-6: Game-based Vocabulary Spelling

Different Letter will fall from the top, players need to pick the right letters and put them into the right places.
Word “Butterfly will be sounded out after spelling correctly

### FIG. 2-7: Game-based Vocabulary Listening Comprehension

Words will be sounded out to the player.
Many pictures start to pop out and disappear.
Players needs to quickly “touch” the pictures to match the sound to win.

### FIG. 2-8: Game-based Vocabulary Dialog

A sentence will be read to a player.
The player needs to first choose the right answer, then read back to the smartphone.
The program needs to give partial point if the player chooses the right answer, but reads it wrong, or give full point if the player can also sound out correctly. The program needs to have speech recognition capability.

### FIG. 2-9: Game-based Vocabulary Sentence Completion

Many words will show up on the screen of a smart-phone.
Some words are useful to complete the sentence based on vocabulary meaning below. Some are useless.
Players needs to quickly pick the right words and put them into the right order to complete the sentence.
For example, the right answer is “butterflies fly in the sky? It is a beautiful day!
   Step 11 Multi-sensory approach
   It is highly recommended to create many practices and games involving multiple human sensors, for example, ears, eyes, touch, smell, temperature and more.
   Step 12 Student self created contents to share to increase learning efficiency
   It is highly recommended to engage students to create high quality learning contents to share with others. For example, students can write stories using the words and share the stories with other students. Good student engagement will increase learning efficiency.
   Step 13 Create phonics learning materials based on vocabulary development.
   Phonics education connects meaning of words, spelling of words and sounding rules. Existing phonics education is to teach students sounding rules, for example,
if a student learns phonics sounding rules to sound out “oo”, then he/she will likely know how to sound out “pool”;
if this student is born in America, it is very likely he/she already knows the meaning of the word “pool”;
if this student can sound out the word “pool” by following phonics sounding rules, then her/she can recognize the spelling of the word “pool”.
   However, the existing phonics educational system does not work well for vocabulary students, for example,
if a student learns phonics sounding rules to sound out “oo”, then he/she will likely know how to sound out “pool”;
if this student is new to America, it is very likely he/she does not know the meaning of the word “pool” and has never heard of it;
if this student can sound out the word “pool” by following phonics sounding rules, then her/she may learn how to spell the word “pool” by following sounding rules, but does not know the meaning of the word “pool”;
as a result, only the connection between sounding rules and word spelling is learned by this student;
this student still does not know the meaning of the word “pool”;
phonics education, connecting meaning of words, spelling of words and sounding rules, fails for vocabulary students.
   To solve this problem, we need to develop phonics learning materials around vocabulary development. Here is IGE's recommendation:
teach vocabulary words first;
develop phonics learning materials around the words of which the students have already mastered the meanings.
   Step 14 Virtual reality (VR) learning materials
   VR learning materials can greatly improve students' learning efficiency and students' engagement.

### Many Different Types of Virtual Reality Environments

With reference to FIG. 2-10, FIG. 2-11, FIG. 2-12, FIG. 2-13, there are 4 examples of virtual reality environment:
1. Students interact with VR Environment, students can choose their roles, clothing, learning environment and so on.
2. Students can interact with teachers in VR environment.
3. Students interact with each other.
4. Students are only audiences, but actively involved and engaged.
   There can be a lot of different options and types of VR environments.

### Create Dynamic Learning Materials for Different Virtual Reality Environments Accordingly

The important attributes for VR learning materials are students' engagements and interactions.
One example is:
Today, at Ivy Goal Education, students watch videos to learn word definition, usage, listening and pronunciation. This type of learning materials is very static without much interaction between learning materials and students.
With VR learning materials, students can choose characters, accents of the characters, speed of the conversations, environments and various setting to optimize learning efficiency and engagement.
With reference to FIG. 2-14, students can choose characters as a man, or as a flower, or as a fish, or as many other things based on their preferences.
   Another example:
Today, at Ivy Goal Education, students practice listening comprehension of vocabulary words and short phrases by listening to sound recordings.
With VR learning materials, students can actually engage in conversation with VR characters. Not only can students practice listening comprehension, but also practice speaking.
In addition, VR characters can correct students like real teachers.

### Initial Process to Start a Lesson

Step 1 Initial assessment
With reference to FIG. 1, students start with an initial English assessment. Based on assessment results, students will start learning at the lowest level at which they fail to pass. As of right now at IGE, a level is typically a grade level for K-12th grade students. However, ideally, with more development effort, our system should be able to start students at an even more precise level. For example, a student can start at 6.3 grade level instead 6 grade level if 6.3 grade level is more accurate.
Step 2 Select initial lesson materials
As of right now at IGE, students typically complete all the learning materials in an initial lesson following a top down linear sequence. However, with more development effort, especially using artificial intelligence (AI) technology, learning materials in an initial lesson can be dynamically selected for each individual student's needs. For example, if a vocabulary student has good listening comprehension skills, but spells words poorly, then listening comprehension materials can be either reduced or deleted, and amount of spelling words materials can be increased.
Step 3 Students start an initial lesson unit
The learning materials mentioned in FIG. 7, FIG. 2 and FIG. 6 are examples of learning materials in an initial lesson unit. Based on initial assessment results, students will be assigned a level to start.
Step 4 Students can repeat most of learning materials
The learning objective is to help student master these learning materials. 80% is a typically passing score. Students need to redo the learning materials to pass.
Step 5 Change learning material content for repeating the failed exercises
In order to prevent students from cheating by redoing the learning materials without studying, learning contents need to be changed, but the type of learning materials needs to remain the same for the lesson. For example, if a student fails reading comprehension, then another reading comprehension will be provided to redo the exercise.

### Standard Looping to Complete a Lesson

In addition to learning materials in the initial lesson, all the rest of learning materials for a standard lesson will be delivered in standard looping process:
Learning materials will be delivered in multiple units.
Standard looping units will be delivered at time intervals over a time span.

### Each Standard Looping Unit Has Learning Materials from Multiple Previous Lessons

In order to complete a lesson over time interval over a time span, a lesson must be divided and put into different standard looping units. With reference to FIG. 3: standard looping unit 6 after initial lesson unit 6, there are:
Learning materials from lesson 3 (it is called U3 Vocab Quiz Mix)
Learning materials from lesson 4 (it is called U4 Vocab Assessment)
Learning materials from lesson 5 (it is called U5 Write Stories and U5 Vocab Quiz)

### AI Select Learning Materials for Each Unit in Standard Looping

As of right now, students typically complete all the learning materials in a unit following a top down linear sequence. However, with more development effort, especially using artificial intelligence (AI) technology, learning materials in an initial lesson can be dynamically selected for each individual student's needs based on performance in previous learning process.

### Less Learning Materials in Each Standard Looping Unit Comparing to Initial Lesson Unit for the Same Lesson

### Comparing FIG. 3 to FIG. 2:

FIG. 2, as an initial lesson unit, it has 11 learning materials for the same lesson
FIG. 3, as a standard looping unit, it has only 1-2 learning materials for the same lesson
   Initial lesson unit is designed to teach students these grouped and expanded words. Standard looping unit is designed to refresh students' lesson in the initial lesson unit.

### Units to be Delivered Over Time Intervals in Standard Looping

At IGE, we have many students studying 2 times per week, and each time lasts 1 hour. Before IGE's classroom time, students will complete 1 initial lesson unit of learning materials at home for self-studying. During IGE classroom time, teachers will review students' homework and ask students to do standard looping units to refresh and reinforce their knowledge of the previous lessons.
For example,

### Week 1:

On Monday, student John completes initial lesson unit 6 as homework for lesson 6.
On Tuesday, John comes to class. Teacher will review the homework, then ask John to do standard looping unit 6 after initial lesson unit 6. In Standard looping unit 6, here are no learning materials for lesson 6, only learning materials for lesson 3, 4 and 5.
On Wednesday, student John completes initial lesson unit 7 as homework for lesson 7.
On Thursday, John comes to class. Teacher will review the homework, then ask John to do standard looping unit 7 after initial lesson unit 7. In Standard looping unit 7, there are no learning materials for lesson 7, only learning materials for lesson 4, 5 and 6.

### Week 2:

On Monday, student John completes initial lesson unit 8 as homework for lesson 8.
On Tuesday, John comes to class. Teacher will review the homework, then ask John to do standard looping unit 8 after initial lesson unit 8. In Standard looping unit 8, there are no learning materials for lesson 8, only learning materials for lesson 5, 6 and 7.
On Wednesday, student John completes initial lesson unit 9 as homework for lesson 9.
On Thursday, John comes to class. Teacher will review the homework, then ask John to do standard looping unit 9 after initial lesson unit 9. In Standard looping unit 9, there are no learning materials for lesson 9, only learning materials for lesson 6, 7 and 8.
   This example shows:
Student John completes a lesson 6 which is spread out over 4 different units—1 initial unit, 3 standard looping units—over 2 weeks.
On week 1 Monday, John completes initial lesson unit for lesson 6.
On week 1 Thursday, John completes standard looping unit containing lesson 6 materials.
On week 2 Tuesday, John completes standard looping unit containing lesson 6 materials.
On week 2 Thursday, John completes standard looping unit containing lesson 6 materials.
For student John, the time interval for each unit containing lesson 6 materials is 2-4 days: Monday to Thursday, Thursday to next week Tuesday and next week Tuesday to next week Thursday.
The time span is 2 weeks.

### Flexibilities for The Initial Lesson Units, Standard Units, The Time Intervals, and Time Span

The example above shows the current setting being used at Ivy Goal Education for some students,
A lesson starts with an initial lesson unit.
Different materials for the same lesson then loop 3 times in each following standard looping unit before a lesson completes.
Time interval is 2-4 days between looping units.
Time span is 2 weeks.
   Moreover, the looping system can deliver great results with a lot of different settings. For example:
Initial lesson units can contain learning materials from previous lessons to serve the looping needs.
Standard looping units do not have to contain previous lesson materials for a certain lesson in a sequential order. For example, for lesson 6, instead of looping the lesson 6 learning materials 3 times in a row, lesson 6 materials can be looped 3 times over 6 different standard looping units randomly. Out of the 6 units, only 3 units have lesson 6 learning materials.
The number of times to loop the lesson materials can be flexible, but minimum of 2 times is highly recommended.
Time interval can be flexible between the initial lesson unit and standard looping units for the same lesson.
Time interval between lesson materials in different standard looping units can be flexible.
Time span to complete a lesson does not have to be 2 weeks. It can be flexible, somewhere between 1-4 weeks.
   The key innovation is to complete a lesson over time intervals over a time span. Time intervals are often in days. Time span is often in weeks.

### Reassessment Units to Measure Results for Lessons Completed After Initial Lessons and Standard Looping

With the reassessment results, we can:
Determine students' learning effectiveness.
Make adjustment recommendations to the current learning settings.
Identify students' weaknesses after the lessons.
Identify words that students fail to learn.

### Use Reassessment Results to Make Adjustments

Each student is different. Therefore to obtain optimal results, adjustments often need to be made frequently. For example:
Add or delete the types of learning materials.
Increase or decrease the amount of certain types of learning materials.
Ask students to repeat certain lessons.
Have students to skip certain future lessons.

### Reassess After an Interval From Completing a Standard Lesson

Students are traditionally assessed right after they finish learning something. However, it is highly recommended to have an interval between reassessment and completing a lesson. The interval is often 1-2 weeks.
With reference to FIG. 1, there is an interval between lesson 6 completion and reassessment.

### Selective Looping to Ensure Mastery of Learning

It is typically that students learn majority of the words through the initial lesson and standard looping. However, there will be words that students will easily forget. These words are often hard words.
In order to help students to master all the words in lessons, additional selective lessons are needed.

### Start Selective Looping Lesson After an Interval from Completing a Standard Lesson

It is highly recommended to have an interval between selective looping lesson and completing a standard lesson. The interval is often at least 1 day.
With reference to FIG. 1, there is about 2-4 days interval from the completion of standard lesson 6 to selective looping lesson covering standard lesson 6. If students still have not mastered some of the learning materials in lesson 6, these materials can be put into next selective looping lesson.

### Create Selective Looping Lessons

Selective looping lessons can be created based on the following options:
Pre-selected general hard words manually.
Words that students have previously fails in initial lesson units.
Words that students have previously fails in standard looping units.
Words that students have previously fails in reassessment units.
Combinations of the options above.

### Options to Deliver Selective Looping Lessons

Selective looping lessons can stand alone in selective looping units or be put into other standard looping units for convenience.
Good results can be achieved as long as selective looping lessons are delivered over time intervals over a time span.

### Learning Management System (LMS) Requirements

After the lessons are created and looping methods are designed, a powerful learning management system is needed to host and deliver the content and methods.
Step 1 This LMS needs to be web based or can be updated online.
If it is web based, then students can access IGE English educational system directly online and each user's system and program update can be achieved by updating at central server.
If it is not web based, but can be updated online, each user's system and program update can be achieved by updating at central server.
Step 2 This LMS needs to be able to support the “looping” method.
The LMS needs to have the flexibility to host various types of contents created around the vocabulary units. More importantly, course designers can fairly easily implement the “looping” method.
Step 3 This LMS needs to offer many authority levels for different users
There will be many different levels of users, such as, Admin, Teachers, Course Designers, Teaching Assistant, Students . . . Each type of users will have different type of access level and authority to use and modify the contents.
Step 4 This LMS needs to offer flexibility to change contents Some users, such as, admin, teachers, assistants and designers, need to have the ability to update contents based on users feedback.
Step 5 This LMS needs to offer the ability to link to outside programs and learning content.
It is highly likely that outside programs and learning content will be linked to this LMS system in order to deliver the best results. For example:
Online classroom program can be linked in order to offer online live teaching with the materials.
Game-based program can be linked in order to make the learning fun. It is often difficult to create game-based learning materials in the LMS. Game-based contents can be created in a game program and linked to the LMS.
Virtual reality materials can be linked in order to make the learning more engaging and efficient. It is often difficult to create virtual reality materials in the LMS. Virtual reality materials can be created in a virtual reality program and linked to the LMS.
Online video can be linked. For example, we can host online videos on Youtube and link the videos to the LMS.
Online document programs can be linked. For example, we can link Google Documents to the LMS to allow students to share their writings.

### Utilize Artificial Intelligence (AI) to Further Improve The System Quality

AI is the theory and development of computer systems, such as a server or general purpose computer, to be able to perform tasks that normally require human intelligence, such as visual perception, speech recognition, decision-making, and translation between languages. AI has become more and more powerful. The use of AI can greatly improve this vocabulary educational system.
Step 1 Use AI to assess students' skill level. Based on student's answers on earlier questions, AI can choose next level of vocab assessment for students. By doing this, we can shorten the assessment time and improve assessment accuracy.
Step 2 Use AI to eliminate known words from vocabulary units or eliminate entire unit from studying system so that students do not need to study the words that they already learned before.
Step 3 Use AI to create selective looping lessons. For example, after completion of a standard lesson, students still do not master certain words. AI can memorize these words, group them and create selective looping lessons for students to study until they achieve mastery level.
Step 4 Use AI to adjust the numbers of learning materials in future lessons For example, based on students' previous performance on standard lessons and/or reassessment, the numbers of learning materials in the future lessons can be adjusted.
Step 5 Use AI to adjust the types of learning materials in future lessons For example, based on students' previous performance on standard lessons and/or reassessment, the types of learning materials in the future lessons can be adjusted.
In summary, use of AI can greatly improve this vocabulary learning system.

Any method or embodiment disclosed herein can be implemented by a computer, server, software, circuitry, hardware, combinatorial logic, web-based system of hardware and/or computer nodes, cloud-computing-based collection of computer-based nodes, or any combination thereof. The processes, methods, and/or embodiments explained above are described in terms of computer software and hardware. The techniques described may constitute machine-executable instructions embodied within a machine (e.g., computer) readable storage medium, that when executed by a machine will cause the machine to perform the operations described. Additionally, the processes, methods, and/or embodiments may be embodied within hardware, such as an application specific integrated circuit (“ASIC”) or the like. Furthermore, the processes and/or methods may be implemented in terms of software instructions on either a processing means, such as a microprocessor or processor, within a server and/or a computer.

The various embodiments of the structure and method of this invention that are described above are illustrative only of the principles of this invention and are not intended to limit the scope of the invention to the particular embodiments described. In view of this disclosure, those skilled-in-the-art can define other flow control styles, other edge conditions, other hardware description functions, other combinations of assignment conditions, other logic elements that may be created, other minimization techniques other than boolean logic, circuits other than digital circuits, and running in a non-computer environment.

1. A system for improving English as A Second Language (ESL) educational system efficiency to improve upon vocabulary learning where the main English learning objective, the system comprising:
at least one processor;
at least one memory, the memory coupled to the at least one processor, to store instructions for execution by the processor to execute the following steps:
perform, by the at least one processor, at least one initial English skill level assessment corresponding to at least a student respectively,
assign, by the at least one processor, at least one set of learning materials corresponding to the at least one student respectively based upon the assessed at least one English language skill level corresponding to the at least one student; and
assign, by the at least one processor, at least one learning process corresponding to the at least one student respectively based upon the assessed at least one English language skill level corresponding to the at least one student,
wherein improving ESL educational system efficiency comprises using artificial intelligence (AI) to adjust a number and types of learning materials for teaching based on the at least one student's performance on assessments,
and wherein enforcing learning materials creation and allocation follow easy-to-difficult step by step learning rule of the ESL educational system by creating a least one group of words based on similar difficulty level and relevance, then creating at least three different learning materials based the at least one group of words,
wherein improving knowledge retention rate and vocabulary memorization retention rate of ESL educational system by delivering a least three different learning materials, each learning material comprising usage of at least one word from the group of words to create upon, with at least one time interval which is at least 1 day, over a time span of at least 1 week.

2. The system of claim 1,
wherein the at least one initial English skill level assessment comprises at least one vocabulary assessment, and
improving initial assessment system accuracy and placement accuracy of the ESL educational system by weighting vocabulary related material scores to be a main measurement based on total scores of an ESL assessment;
wherein vocabulary related materials comprise word definition, word translation, using words in phrases, listening of words, sounding out words, filling blank using word, complete sentences using words, sentence translation using words, vocabulary games using words, sentence writing using words, and dialog using words.

3. The system of claim 1,
wherein at least two learning materials, for the same grouped words and their expanded words, will be assigned to a student's lesson based on assessment results.

4. The system of claim 1,
wherein learning materials designed based on both grouped words and expanded words, and
vocabulary learning is the core of the English instruction, and other learning materials are built around vocabulary words.

5. The system of claim 4,
wherein phonics learning materials are based on both grouped words and expanded words.

6. The system of claim 4,
wherein writing sentence and stories is based on both grouped words and expanded words.

7. The system of claim 4,
wherein game-based learning materials are based on both grouped words and expanded words.

8. The system of claim 4,
wherein virtual reality learning materials are based on both grouped words and expanded words.

9. The system of claim 4,
wherein dual language learning materials for non-native English speaking students are based on both grouped words and expanded words.

10. The system of claim 1,
wherein artificial intelligence (AI) adjusts the number and types of learning materials for the standard lesson based on the student's performance on initial assessment, and/or initial lesson, and/or standard looping, and/or reassessment, and/or selective looping.

11. The system of claim 1,
wherein artificial intelligence (AI) adjusts the number and types of learning materials for a selective lesson based on the student's performance on initial assessment, and/or initial lesson, and/or standard looping, and/or reassessment, and/or selective looping.

12. The system of claim 1,
wherein a learning process will assign learning materials to a student, and further comprises:
learning materials will be spread out and looped at multiple looping time intervals over a time span, and further comprises:
at least one initial lesson unit will be assigned based on assessment results, and
at least one standard looping unit will be assigned after the at least one initial lesson unit, and
at least one reassessment unit will be assigned after the at least one standard looping unit, and
at least one selective looping unit is conditionally associated with students' performance based on the at least one initial lesson unit, the at least one standard looping unit, and the at least one reassessment unit.

13. The system of claim 12,
wherein the standard lesson for the same grouped and expanded words will be spread into multiple units: the at least one initial lesson unit, the at least one standard looping unit, and the at least one reassessment unit.

14. The system of claim 12,
wherein the at least one standard looping unit contains learning materials from multiple different lessons.

15. The system of claim 12,
wherein the at least one standard lesson will be delivered in multiple standard looping units over time intervals over a time span, and further comprises:
the number of standard looping units to contain learning materials for the standard lesson is at least 1, and
the time interval between the initial lesson unit and the first standard looping unit or between the first standard looping unit and the second standard looping unit is at least 1 second, and
the time span to completely deliver all the learning materials for the standard lesson is at least 1 minute.

16. The system of claim 12,
wherein the each selective lesson comprises meaningful and related words from the following groups:
pre-selected general hard words manually,
words that students have previously fails in initial lesson units,
words that students have previously fails in standard looping units,
words that students have previously fails in reassessment units,
a combinations of the options above.

17. The system of claim 12,
wherein the selective lesson will be delivered in multiple units over time intervals over a time span, and further comprises:
the number of selective looping units to contain learning materials for the selective lesson is at least 1, and
the time interval between the standard looping unit and the first selective looping unit or between the first selective looping unit and the second selective looping unit is at least 1 second, and
the time span to completely deliver all the learning materials for the selective lesson is at least 1 minute.

18. The system of claim 12,
wherein artificial intelligence (AI) adjusts the number of times that learning materials for the standard lesson and/or the selective lessons are to be delivered.

19. A method for improving English as A Second Language (ESL) educational system efficiency to improve upon vocabulary learning where the main English learning objective, the method comprising:
using at least one processor and at least one memory, the at least one memory coupled to the at least one processor, to store instructions for execution by the at least one processor to execute the following steps:
perform at least one initial English skill level assessment corresponding to at least a student respectively,
assign at least one set of learning materials corresponding to the at least one student respectively based upon the assessed at least one English language skill level corresponding to the at least one student;
assign at least one learning process corresponding to the at least one student respectively based upon the assessed at least one English language skill level corresponding to the at least one student; and
wherein improving ESL educational system efficiency comprises using artificial intelligence (AI) to adjust a number and types of learning materials for teaching based on the at least one student's performance on assessments,
and wherein enforcing learning materials creation And allocation follow easy-to-difficult step by step learning rule of ESL educational system by creating at least one group of words based on similar difficulty level and relevance, then creating at least three different learning materials based the at least one group of words,
wherein improving knowledge retention rate and vocabulary memorization retention rate of the ESL educational system by delivering at least three different learning materials, each learning material comprising usage of at least one word from the group of words to create upon, with at least one time interval which is at least 1 day, over a time span of at least 1 week.

20. A non-transitory medium of for improving English as A Second Language (ESL) educational system efficiency to improve upon vocabulary learning where the main English learning objective, the non-transitory medium being coupled to at least one processor and at least one memory, the memory coupled to the at least one processor, to store instructions for execution by the processor to execute the following steps:
perform at least one initial English skill level assessment corresponding to at least a student respectively,
assign at least one set of learning materials corresponding to the at least one student respectively based upon the assessed at least one English language skill level corresponding to the at least one student;
assign at least one learning process corresponding to the at least one student respectively based upon the assessed at least one English language skill level corresponding to the at least one student; and
wherein improving ESL educational system efficiency comprises using artificial intelligence (AI) to adjust a number and types of learning materials for teaching based on the at least one student's performance on assessments,
and wherein enforcing learning materials creation and allocation follow easy-to-difficult step by step learning rule of the ESL educational system by creating at least one group of words based on similar difficulty level and relevance, then creating at least three different learning materials based the at least one group of words,
wherein improving knowledge retention rate and vocabulary memorization retention rate of the ESL educational system by delivering at least three different learning materials, each learning material comprising usage of at least one word from the group of words to create upon, with at least one time interval which is at least 1 day, over a time span of at least 1 week.
